(19) United States
(12) Patent Application Publication
(10) Pub. No.: US 2008/0092048 A1
(43) Pub. Date: Apr. 17, 2008

(54) Data Processor

(76) Inventor: Kenji Morimoto, Hyogo (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/722,721

(22) PCT Filed: Dec. 14, 2005
(86) PCT No.: PCT/JP05/22929

§ 371 Date: Jun. 25, 2007

(30) Foreign Application Priority Data
Dec. 27, 2004 (JP) 2004-377034

(51) Int. Cl. G06F 3/00

(52) U.S. Cl. 715/719

(57) ABSTRACT

To detect boundaries between the content of a telecast, for example, and commercial messages, included in the telecast, highly accurately when the user is deleting the commercial messages. A data processor includes: a picture level detecting section, which receives a video signal including a plurality of pictures and detects the signal level of a predetermined one of the pictures based on the signal; a frame memory section for storing the data of the pictures; and a controller for adding index information. The picture level detecting section specifies a video changing point by reference to the respective signal levels of multiple consecutive pictures and the controller adds the index information to a data location, corresponding to the changing point, in a data stream.

### TECHNICAL FIELD

The present invention relates to a technique of reading a video signal representing a digital broadcast, for example.

### BACKGROUND ART

Digital recorders/players for recording video, audio and other types of information, which is transmitted in the digital form, on a storage medium such as an optical disk have become increasingly popular these days. A digital video bitstream to be recorded on such a storage medium is ordinarily compressed by an intra- or inter-frame data compression technique compliant with the MPEG-2 (Moving Picture Experts Group) standard, for example, to make an efficient use of the storage capacity of the storage medium.

Also, when a digital player is used to play a recorded storage medium, a playback start point may be specified by the user according to his or her preference and saved either in a memory or on a storage medium to enable him or her to start playback at his or her specially designated point. Among other things, in digital recorders/players that enable the user to alter the stored data many times, there is particularly high demand for the editing function of deleting or combining recorded video and audio according to his or her preference. And some recorders/players have already realized that function. In doing such editing, commercial messages inserted into TV programs recorded often need to be deleted.

Also, the user who thinks the commercial messages recorded unnecessary would likely skip commercial message parts by fast forwarding during playback. In both cases, the boundaries between the content of the recorded TV program itself and the commercial messages need to be detected automatically. To meet such demand, recorders/players for skipping commercial messages by putting indices on video and audio signals recorded at the boundaries between the TV program itself and the commercial message parts and fast forwarding those parts automatically during playback have been proposed.

Hereinafter, the configuration and operation of a conventional recorder/player 170 will be described with reference to FIG. 7.

FIG. 7 shows an arrangement of functional blocks in the conventional recorder/player 170, which includes an antenna 71, a digital tuner 72, a read/write section 73, a microcontroller 3, a stream separating section 4, a video decoding section 5, a frame memory section 6, a GUI (graphic user interface) mixing section 8, a video output terminal 9, an audio decoding section 10 and an audio output terminal 11. The storage medium 1 is supposed to be an optical disk, for example.

In this recorder/player 170, a broadcast wave, received at the antenna 71, is passed to the digital tuner 72 and demodulated into a digital bitstream including audio and video there. The read/write section 73 converts the digital bitstream signal into a signal to be written and then writes it on the storage medium 1. The digital audiovisual signal being written on the storage medium 1 is also separated by the stream separating section 4 into a video bitstream and an audio bitstream, which are then supplied to the video decoding section 5 and the audio decoding section 10, respectively. In the video decoding section 5, the incoming video bitstream is decoded by the frame memory section 6, thereby obtaining reproduced decoded image.

If necessary, a GUI image, representing an on-screen device operating interface for users, is added by the GUI mixing section 8 to the decoded image. Then, the combined image is output through the video output terminal 9 and connected to a TV, for example. Meanwhile, the audio signal, decoded by the audio decoding section 10, is output through the audio output terminal 11 and then connected to a TV, for example. In this case, the moment when the audio modes change from stereo into monaural or dual monaural (a bilingual telecast) is detected by the audio decoding section 10 and that information is conveyed to the microcontroller 3.

At the audio mode changing point, detected during recording, the microcontroller 3 writes an index signal, representing an index point, on the storage medium 1. In this manner, the index signal can be written on the boundaries between the content of a TV program and commercial messages in a situation where the program is either dual monaural (bilingual) or monaural and the commercial messages are stereo, or vice versa.

Consequently, by automatically switching the modes of operation from normal playback mode into fast forward playback, and vice versa, every time the index signal is detected during playback, either the commercial messages or non-commercial message parts can be fast-forward played automatically.

The specific example described above is a recorder/player that uses a digital broadcast and an optical disk as a storage medium. However, even a recorder/player such as a digital VCR that also receives analog broadcasts can also realize the automatic commercial message skipping function by quite the same technique. The commercial message deleting function is also realized by allowing the user to do editing at the index points (i.e., at data locations where the index signal is detected).
Patent Document No. 1: Japanese Patent Application Laid-Open Publication No. 6-295488

### DISCLOSURE OF INVENTION

### Problems to be Solved by the Invention

In this case, however, the boundaries between the content and the commercial messages are detected by finding the audio mode switching points. That is why the audio mode switching points rarely agree with video changing points completely. Consequently, even if the user wants to get the commercial messages deleted on a frame-by-frame basis, those boundaries may sometimes be detected non-synchronously with the change of pictures. In that case, one scene of a commercial message could be left just a moment or the top of the content could be deleted. Besides, this technique is applicable to only commercial messages that have a different audio mode from the rest of the program. That is to say, a lot of telecasts, except analog bilingual movies, for example, are not processable.

An object of the present invention is to get the boundaries between the content of a program and additional commercial messages automatically detected highly accurately on a frame-by-frame basis by a recorder/player when the user is skipping or deleting the commercial messages.

### Means for Solving the Problems

A data processor according to the present invention includes: a picture level detecting section, which receives a signal that represents video including a plurality of pictures and detects the signal level of a predetermined one of the pictures based on the signal; a frame memory section for storing the data of the pictures; and a controller for adding index information. The picture level detecting section specifies a video changing point by reference to the respective signal levels of a plurality of consecutive pictures and the controller adds the index information to a data location, corresponding to the changing point, in a data stream.

By reference the respective signal levels, the picture level detecting section may detect at least one of a fade-in start point and a fade-out end point of the video and specify that point as the changing point.

The controller may output a detection instruction to start detecting the changing point. In accordance with the detection instruction, the picture level detecting section may detect at least one of a fade-in start point and a fade-out end point of the video and specify that point as the changing point.

The data processor may further include a GUI mixing section for superimposing a GUI image on the video. In accordance with an instruction that has been given by way of the GUI mixing section, the controller may output the detection instruction.

The picture level detecting section may specify either the fade-in start point or the fade-out end point of the video, which has been detected first after the detection instruction has been received, as the changing point.

The controller may define chapters for the video at the changing point.

The data processor may further include a GUI mixing section for superimposing a GUI image on the video. In accordance with a fade-in and/or fade-out detection instruction that has been given by way of the GUI mixing section, the picture level detecting section may detect either the fade-in start point or the fade-out end point of the video and specify that point as the changing point.

The video signal may be a digital signal that has been encoded based on data obtained by breaking down the picture into DC and AC components, and the picture level detecting section may detect the signal levels based on the DC component of the predetermined picture.

The video signal may be an analog signal, and the picture level detecting section may detect the signal level of the predetermined picture based on the signal levels of respective pixels that form the predetermined picture.

The data processor may further include a video decoding section for generating the signal by decoding video data. The picture level detecting section may receive the signal that has been generated by the video decoding section.

The data processor may further include a read section for playing back a data stream, including the video data, from a storage medium. The video decoding section may acquire the video data from the data stream being played back by the read section.

The data processor may further include a receiving section for demodulating a broadcast wave and outputting a data stream including the video data. The video decoding section may acquire the video data from the data stream being output by the receiving section.

The picture level detecting section may specify the changing point for predetermined ones of the intervals of the video.

The picture level detecting section may specify the changing point for the predetermined intervals that have been either specified by a user or selected in advance.

The data processor may further include a GUI mixing section for superimposing a GUI image on the video. The controller may receive an instruction to set the index information for predetermined ones of the intervals of the video and output a detection instruction and a mixing instruction. In accordance with the detection instruction, the picture level detecting section may specify the changing point for the predetermined intervals. And in accordance with the mixing instruction, the GUI mixing section may output the video in the predetermined intervals and show the presence of the changing point specified.

### EFFECTS OF THE INVENTION

According to the present invention, the fade-in or fade-out point is detected based on the levels of pictures that have been decoded by a decoding section during playback, thereby detecting the boundaries between the content of a TV program received and commercial messages highly accurately. Particularly if a boundary located near a playback point that has been specified by the user is detected and if an index signal showing the location of the boundary is written, then editing can be done afterward with high accuracy and efficiency.

### BRIEF DESCRIPTION OF DRAWINGS

FIG. 1 shows an arrangement of functional blocks for a recorder/player 100 according to a first preferred embodiment of the present invention.

FIG. 2 shows an example of a GUI image 12 generated by a GUI mixing section 8.

Portions (a) and (b) of FIG. 3 show the output signals of a picture level detecting section 7.

FIG. 4 is a flowchart showing how the recorder/player of the first preferred embodiment operates in a chapter registering mode.

FIG. 5 shows an example of a GUI image 57 according to a second preferred embodiment of the present invention.

FIG. 6 is a flowchart showing how the recorder/player of the second preferred embodiment operates in a chapter registering mode.

FIG. 7 shows an arrangement of functional blocks for a conventional recorder/player 170.

### DESCRIPTION OF REFERENCE NUMERALS

1 storage medium
2 read section
3 microcontroller
4 stream separating section
5 video decoder
6 frame memory section
7 picture level detecting section
8 GUI mixing section
9 video output terminal
10 audio decoder
11 audio output terminal
12 GUI image
13 window
14 chapter setting button
15 end button
16 time information
17, 18 indicator of current position in entire stream
19 position of index signal
20 through 45 outputs of picture level detecting section
46 In point detecting button
47 Out point detecting button
71 antenna
72 digital tuner
73 read/write section

### BEST MODE FOR CARRYING OUT THE INVENTION

Hereinafter, preferred embodiments of a data processor according to the present invention will be described with reference to the accompanying drawings. A data processor according to first and second preferred embodiments to be described below can perform both playback processing but also editing on video and audio that has been recorded on a storage medium. Since editing processing is usually done by utilizing a recording function, the data processors of the preferred embodiments to be described below are supposed to be recorders/players.

### Embodiment 1

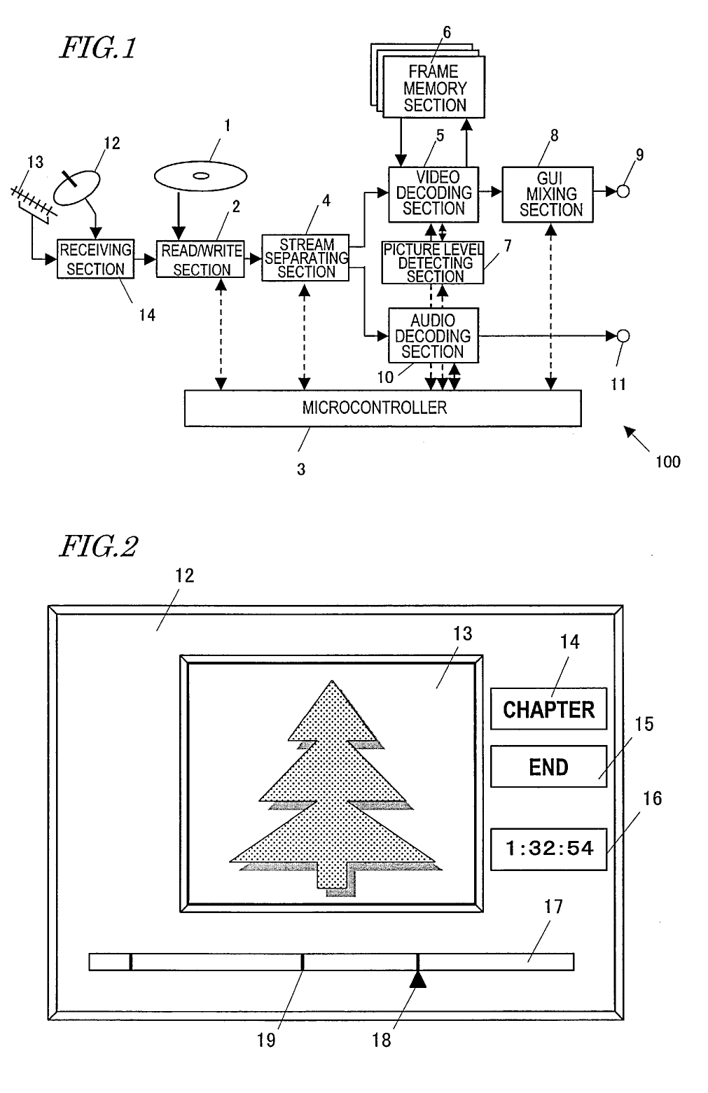

FIG. 1 shows an arrangement of functional blocks for a recorder/player 100 according to a first preferred embodiment of the present invention. The recorder/player 100 includes a read/write section 2, a microcontroller 3, a stream separating section 4, a video decoding section 5, a frame memory section 6, a picture level detecting section 7, a GUI mixing section 8, a video output terminal 9, an audio decoding section 10, an audio output terminal 11, antennas 12 and 13, and a receiving section 14.

The recorder/player 100 can bound-record the data of programs, including audio and video data, on a storage medium 1. Those programs may have been transmitted on a digital or analog broadcast wave.

In FIG. 1, the antenna 12 receives a digital broadcast wave, the antenna 13 receives an analog broadcast wave, and then both of them pass it to the receiving section 14. On receiving the digital broadcast wave from the antenna 12, the receiving section 14 demodulates the digital broadcast wave into an encoded digital bitstream, including audio and video, and outputs the bitstream. On the other hand, on receiving the analog broadcast wave from the antenna 13, the receiving section 14 demodulates the analog broadcast wave into a non-encoded digital bitstream including video and audio (i.e., a so-called “baseband signal”) and outputs the bitstream.

If the bitstream received is the encoded digital bitstream, the read/write section 2 subjects the digital bitstream to a predetermined type of processing and then writes it on the storage medium 1. The predetermined type of processing may be the processing of adding time information to output the digital bitstream in the receiving order during playback.

On the other hand, if the non-encoded digital bitstream has been received, the read/write section 2 compresses and encodes the bitstream compliant with one of the MPEG standards, for example, and then writes it on the storage medium 1.

In this example, a program including video and audio is supposed to be already stored on the storage medium 1. In this preferred embodiment, the storage medium 1 is supposed to be an optical disk such as a Blu-ray disc. It should be noted that the optical disk is usually removable and therefore the storage medium 1 does not form an integral part of the recorder/player 100. If the storage medium 1 is a non-removable medium such as a hard disk, however, then the storage medium 1 may be treated as one of the components of the recorder/player 100.

One of the features of the recorder/player 100 of this preferred embodiment is automatically detecting a fade-in start point or a fade-out end point by the picture level of a frame picture as a component of video. The start point and end point detected are identified as video changing points. Thus, the user can see if those points detected are actually the boundaries between commercial messages and the content of a program. The data processor can put an index point (i.e., insert an index signal) at each video changing point that has been confirmed by the user. In that case, the user can start playback and do editing from any arbitrary index point when he or she carries out editing afterward. As a result, the editing work can be done efficiently. It should be noted that the “start point”, “end point”, “changing point” and “boundary point” all refer to structural units of video.

In this description, the structural unit of video is supposed to be a frame picture. That is to say, video is supposed to be presented by switching a number of frame pictures one after another at a predetermined frequency. It should be noted that frame pictures are just exemplary structural units of video and may be replaced with field pictures, too.

A data stream including video data and audio data, stored on the storage medium 1, may be read by the read section 2 under the instruction given by the microcontroller 3. As used herein, “reading” refers to irradiating the storage medium 1 with a laser beam, receiving its reflected light, and obtaining information from the storage medium 1 based on that reflected light. On the storage medium 1, pits (or marks) have been formed so as to represent the information stored. By taking advantage of the fact that pits and the other portions of the medium have mutually different optical properties, information can be written on, and read from, the medium.

The data stream played back is a bitstream such as an MPEG-2 TS (transport stream) that is made up of multiple TS packets. A TS packet is usually made up of a transport packet header of 4 bytes and payload of 184 bytes. In the packet header, a packet identifier (PID) showing the type of that packet is described. For example, the PID of a video TS packet is 0x0020, while that of an audio TS packet is 0x0021. The payload may include elementary data and additional information. The elementary data may be content data such as video data or audio data or control data for controlling the playback. The type of the data stored there changes according to the type of the packet.

The stream separating section 4 separates the stream into TS packets including video data and TS packets including audio data by reference to the packet IDs, and extracts and outputs the video data and audio data from those separated packets. The output video data is decoded by the video decoding section 5 using the frame memory section 6 and then transmitted as a video signal to the GUI mixing section 8. In response, the GUI mixing section 8 superposes an image signal, representing an interface that allows the user to operate the device easily, on the video signal, thereby generating a composite video signal, which is output through the video output terminal 9. On the other hand, the audio data is decoded by the audio decoding section 10 and then output as an audio signal through the audio output terminal 11.

Following this procedure, the recorder/player 100 reads video, audio and other types of information from the storage medium 1 and outputs a video (or image) signal and an audio signal. Among other things, the GUI mixing section 8 can superimpose an interface image, which allows the user to operate the device easily, on the video to present. Through this interface image, the user can put an index point at his or her desired video frame. As used herein, “putting an index point” means making an index such that playback may be started from any arbitrary video frame, and more specifically refers to adding or inserting an index signal (i.e., information representing an index) to a particular data location. As the index signal, information representing addresses on the storage medium may be used. That is to say, the address information of data locations at which the index points should be put may be separately stored on the storage medium 1. By reading the address information during playback, the recorder/player 100 can play back the bitstream from any location on the storage medium 1 as specified by the address information. The index signal may be added and inserted in accordance with the instruction given by the microcontroller 3, for example.

The index point can be used not only to start playing back the stream from any desired point easily but also to make an editing work by cutting off the stream. That is to say, the index point may be used to do various types of editing, including splitting a stream at a particular data location, partially deleting the stream from an index point to another, and defining a chapter from an index point to another and rearranging or partially deleting the stream on a chapter-by-chapter basis. In getting these types of editing done, the index points are preferably set precisely on a frame-by-frame basis.

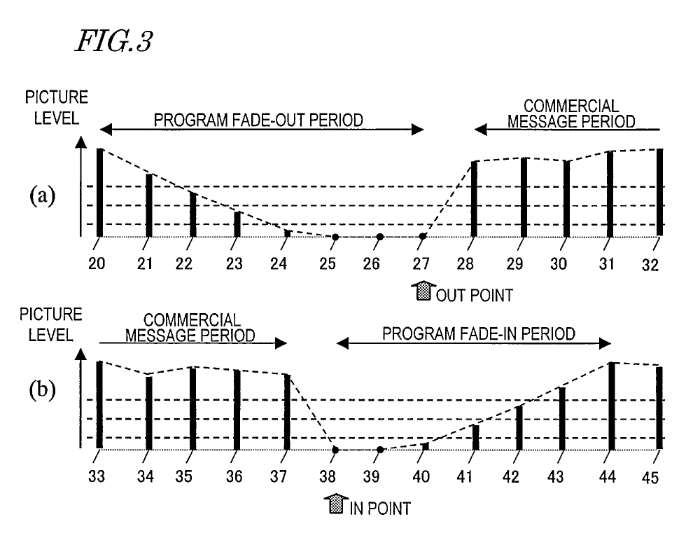

FIG. 2 shows an example of a GUI image 12 generated by a GUI mixing section 8. This GUI image 12 is presented on the screen of a display device such as a TV monitor. In this example, the image to be presented is reduced to the size of a window 13 so as to be presented within the window 13 when playback operation is carried out. On the screen, a chapter setting button 14 is provided so as to allow the user to define chapters by inserting the index signal into his or her desired frame using a remote controller, for example. In this case, the user can search for his or her desired frame on the screen while checking the content by fast-forwarding the pictures or by playing back the pictures either slowly or frame by frame advance. As a result, he or she can put an index point at an appropriate frame. A chapter may be defined by specifying a pair of index points corresponding to the top and the end of the chapter.

When the user presses the end button 15 on the screen to indicate that the editing work be ended, a window 16 showing the duration of the recorded program as counted from its top may be maximized to the entire screen 12, for example. On the screen, also presented is a bar 17 showing the playback duration of the entire stream with a current location 18 in the stream. In searching for his or her desired presentation start point, the user can use these pieces of additional information by looking at these forms of images on the screen. On the bar, it is also shown schematically when and where in the stream the index signal has been inserted. By using this GUI image 12, the user can put an index signal basically at any arbitrary presentation point specified by him or her and define a chapter.

In this preferred embodiment, when the user presses the chapter setting button after the modes of operations have been changed into a mode that enables fade-in/fade-out point detection or while the fade-in/fade-out point can always be detected, the fade-in/fade-out points may be detected automatically from a range that is N seconds before and after that point in time and the chapter can be defined. In this case, N may either be set arbitrarily by the user or have been specified in advance. As described above, when a chapter is defined, the index signal is written (i.e., the index point is set). That is why the index points can be set in an arbitrary range. That is to say, when the chapter setting button is pressed, the index points and a chapter to be set are specified by the user.

Hereinafter, it will be described with reference to FIG. 3 exactly how to detect the fade-in/fade-out points. Portions (a) and (b) of FIG. 3 show the output signals of a picture level detecting section 7, which detects and outputs the picture levels at the times 20 through 32 shown in portion (a) of FIG. 3 and at the times 33 through 45 shown in portion (b) of FIG. 3. This “picture” is a structural unit of video and may also be called a “frame”, for example. By switching a plurality of pictures one after another at a predetermined frequency (e.g., 30 Hz according to the NTSC standard), video is presented. The interval between each pair of the times shown in FIG. 3 is the playback duration of each video frame. That is to say, portions (a) and (b) of FIG. 3 show the variation in the picture level of the decoded image on a frame-by-frame basis.

In an MPEG-2 stream, for example, the picture level may be calculated based on the DC components of a DCT (discrete cosine transform) block consisting of eight by eight pixels. In an MPEG-2 video elementary stream, the video signal is compressed and picture data is transmitted using a hierarchical structure including a picture layer, a slice layer and a macroblock layer, of which the sizes decrease in this order. The DCT block is transmitted in the macroblock layer. According to a frame structure, for example, the same number of picture data as that obtained by dividing one frame picture by the DCT blocks, each consisting of eight by eight pixels, are transmitted.

In each DCT block, DC components representing the average picture level of the eight by eight pixels and AC coefficients representing the frequency components of the eight by eight pixels are included and transmitted sequentially. When the video decoding section 5 decodes the data of the macroblock layer, the picture level detecting section 7 may add together the DC component values within one frame picture period or calculate the average thereof, thereby obtaining the DC component value of one entire frame as either the sum or the average of the same number of picture levels as that of the DCT blocks. In portions (a) and (b) of FIG. 3, the values obtained in this manner are shown as the picture levels of respective frames.

For example, portion (a) of FIG. 3 shows a situation where a scene of the program received fades out into black display once, and immediately switched into a commercial message. The picture level decreases smoothly one frame after another in Frames #21 to #24 to reach an almost zero level (i.e., the picture has faded out) in Frames #25, #26 and #27. Then, in the first frame #28 representing the commercial message, the picture level increases steeply. For example, the picture level detecting section 7 may monitor the picture levels by setting the three levels indicated by the dashed lines. And the picture level detecting section 7 can easily detect a fade-out state if the picture level is decreasing monotonically one frame after another to enter the lowest level zone. Also, in Frame #28, the picture level abruptly rises above the second level from the lowest level zone in Frame #27, which means that video has started to be presented suddenly in the black display state. That is why in this example, Frame #27 may be regarded as the last frame of the faded-out video as indicated by the arrow with “out point”.

In the same way, portion (b) of FIG. 3 shows exactly how to detect a fade-in point. Suppose the frame in which the picture level goes all the way down to the lowest level zone passing all three levels indicated by the dashed lines is Frame #38. After that, the picture level increases monotonically one frame after another in Frames #39 to #43. That is why as indicated by the arrow “in point”, the fade-in has not started until Frame #38, i.e., Frame #38 may be regarded as the fade-in (start) point.

In the example described above, the fade-in and fade-out points are detected with those three level set. However, fade-in and fade-out points can also be detected with any of various other adjustments and precisions.

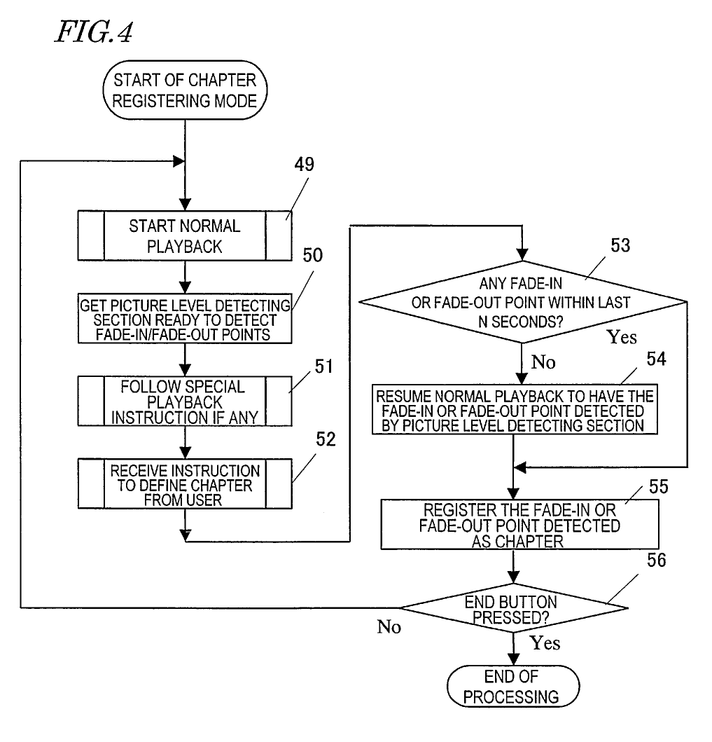

Hereinafter, it will be described with reference to FIG. 4 how the recorder/player 100 of this preferred embodiment operates. FIG. 4 shows how the recorder/player 100 operates in a chapter registering mode. In entering the chapter registering mode, the processing of putting an index point as specified by the user is carried out. First, in Step 49, the GUI image 12 shown in FIG. 2 is presented to start a normal playback operation. Next, in Step 50, the picture level detecting section gets ready to detect fade-in and fade-out points. If the user has selected any special playback mode in Step 51 to search for a particular scene, a fast-forwarding, slow or frame-by-frame playback operation is started as instructed. And when the user finds a fade-in or fade-out point around a location where the index point should be put by monitoring the pictures on the screen or if he or she thinks that a fade-in or fade-out point will appear soon, he or she instructs in Step 52 that a chapter should be defined. Next, in Step 53, it is determined whether or not a fade-in or fade-out point has appeared within the last N seconds. If the answer is YES, the process advances to Step 55, in which the picture level detecting section 5 and the microcontroller 3 that have been searching for the fade-in and fade-out points put an index point on that frame, where the fade-in or fade-out point has been detected, and register the chapter. Otherwise, the process advances to Step 54, in which a normal playback operation is performed from the point specified by the user to detect a fade-in or fade-out point. After that, the process advances to Step 55, in which an index point is put on the frame where the fade-in or fade-out point has been detected and a chapter is registered.

Thereafter, in Step S56, it is determined whether or not the end button 15 has been pressed. If the answer is NO, the operation of putting the next index point will be further performed. On the other hand, if the answer is YES, the chapter registering mode is ended. For example, the presentation of the GUI image 12 is finished to return to a normal playback mode.

In the processing steps 53 and 55, an approximate fade-in or fade-out location is found by playing back the video, and then the chapter setting button is just pressed, thereby putting an index point on any desired frame accurately on a frame-by-frame basis and making a chapter. That is why there is no longer any need for the user to perform slow and frame-by-frame playback over and over again in order to find a fade-in or fade-out point either in a boundary between the content and a commercial message or at a scene change point. As a result, this recorder/player should come in much handier for him or her.

By detecting the index signal that has been inserted as an index point into a frame, various functions are realized. For example, playback may be started from that frame, commercial messages may be skipped automatically during playback or editing can get done on a chapter-by-chapter basis. Particularly when commercial messages need to be deleted at a number of points by editing, editing points can be set highly efficiently and accurately.

In the preferred embodiment described above, the index point is supposed to be put near the frame that has been specified by the user on the GUI image 12. Alternatively, the index point may also be put by finding every fade-in or fade-out point fully automatically without receiving any instruction from the user during playback.

### Embodiment 2

A recorder/player according to a second preferred embodiment of the present invention has quite the same configuration as the counterpart of the first preferred embodiment described above as shown in FIG. 1. That is why the recorder/player of this preferred embodiment will also be referred to herein as the “recorder/player 100”. In the first preferred embodiment described above, the index point is supposed to be put by searching for a fade-in or fade-out point with the single chapter setting button 14 pressed on the GUI image 12 shown in FIG. 2.

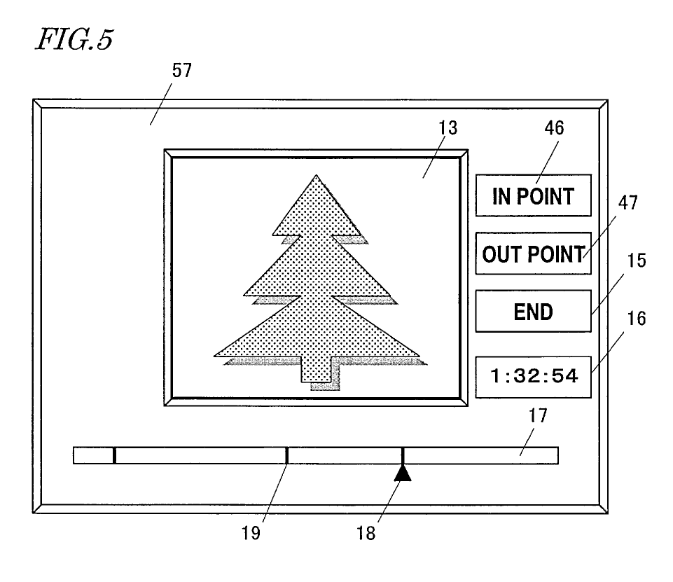

On the other hand, according to this preferred embodiment, the index point can be put by detecting a fade-in or fade-out point under an explicit instruction given by the user. FIG. 5 shows an example of a GUI image 57 according to this preferred embodiment. Unlike the GUI image 12 of the first preferred embodiment shown in FIG. 2, the GUI image 57 includes an IN point detecting button 46 and an OUT point detecting button 47 instead of the chapter setting button 14. When the user gives his or her instruction by pressing these two buttons, the recorder/player 100 can detect the fade-in and fade-out points separately and can put index points for them.

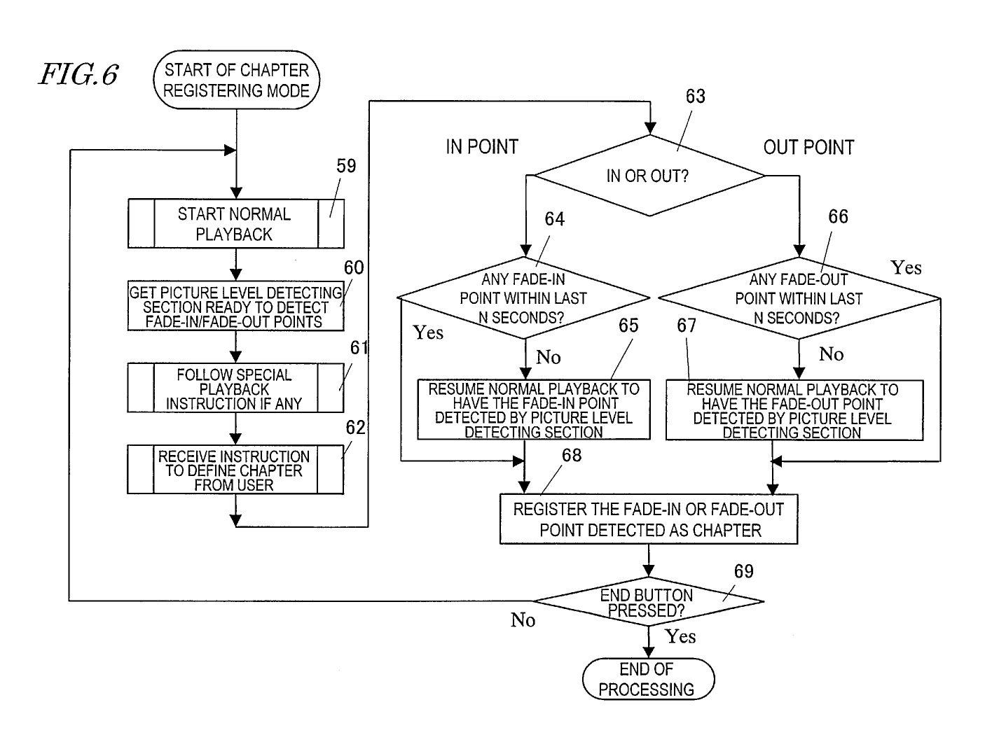

Hereinafter, it will be described how the recorder/player 100 of this preferred embodiment operates. FIG. 6 shows how the recorder/player 100 operates in a chapter registering mode. In entering the chapter registering mode, the processing of putting an index point at the user's instruction is carried out. First, in Step 59, the GUI image 57 shown in FIG. 5 is presented to start a normal playback operation. Next, in Step 60, the picture level detecting section gets ready to detect fade-in and fade-out points. If the user has selected any special playback mode in Step 61 to search for a particular scene, a fast-forwarding, slow or frame-by-frame playback operation is started as instructed. And when the user finds a fade-in or fade-out point around a location where the index point should be put by monitoring the pictures on the screen or if he or she thinks that a fade-in or fade-out point will appear soon, he or she instructs in Step 62 that a chapter should be defined.

At this point in time, the user decides whether he or she wants to find a fade-in point or a fade-out point and presses one of the two buttons 46 and 47. In Step 63, it is determined which of the two buttons 46 and 47 has been pressed. If the fade-in point detection instruction has been given by pressing the button 46, the process advances to Step 64, in which the picture level detecting section 5 and the microcontroller 3 that have been searching for the fade-in point advance to Step 68 to put an index point on that frame, where the fade-in point has been detected, and register the chapter. If no fade-in point has been detected within the last N seconds, the process advances to Step 65, in which a normal playback operation is performed from the point specified by the user to detect a fade-in point. After that, the process advances to Step 68, in which an index point is put on the frame where the fade-in point has been detected and a chapter is registered.

On the other hand, if the fade-out point detection instruction has been given by pressing the button 47, the process advances to Step 66, in which if a fade-out point has appeared within the last N seconds, the picture level detecting section 5 and the microcontroller 3 that have been searching for the fade-out point advance to Step 68 to put an index point on that frame, where the fade-out point has been detected, and register the chapter. However, if no fade-out point has been detected within the last N seconds, the process advances to Step 67, in which a normal playback operation is performed from the point specified by the user to detect a fade-out point. After that, the process advances to Step 68, in which an index point is put on the frame where the fade-out point has been detected and a chapter is registered.

Thereafter, in Step S69, it is determined whether or not the end button 15 has been pressed. If the answer is NO, the operation of putting the next index point will be further performed. On the other hand, if the answer is YES, the chapter registering mode is ended. For example, the presentation of the GUI image 57 is finished to return to a normal playback mode.

In the processing steps 63 through 68, an approximate location is found by playing back the video, and then one of the two buttons is just pressed by deciding whether a fade-in point or a fade-out point should be detected, thereby putting an index point on any desired frame accurately on a frame-by-frame basis and making a chapter. Specifically, when the content of a program changes into a commercial message, the content often fades out. On the other hand, when a commercial message changes into the content, the content often fades in. That is why if the user wants to put an index point at any of these locations, he or she needs to decide whether he or she wants to detect a fade-in point or a fade-out point and detect a program boundary. In addition, not just in the boundaries between the content of a program and commercial messages but also at the beginning and the end of a frame that begins by fading in and ends by fading out (such as a singer's promotional video or one scene of a video) can the index points be put efficiently. Consequently, there is no longer any need for the user to perform slow and frame-by-frame playback over and over again in order to find a fade-in or fade-out point either in the boundary between the content and a commercial message or at a scene change point. As a result, this recorder/player should come in much handier for him or her.

Once the index point has been put, various functions are realized as already described for the first preferred embodiment by detecting the index signal that has been inserted as the index point into a frame. For example, playback may be started from that frame, commercial messages may be skipped automatically during playback or editing can get done on a chapter-by-chapter basis. Particularly when commercial messages need to be deleted at a number of points by editing, editing points can be set highly efficiently and accurately.

In the preferred embodiment described above, the index point is supposed to be put near the frame that has been specified by the user on the GUI image 57. Alternatively, the index point may also be put by finding every fade-in or fade-out point fully automatically without receiving any instruction from the user during playback.

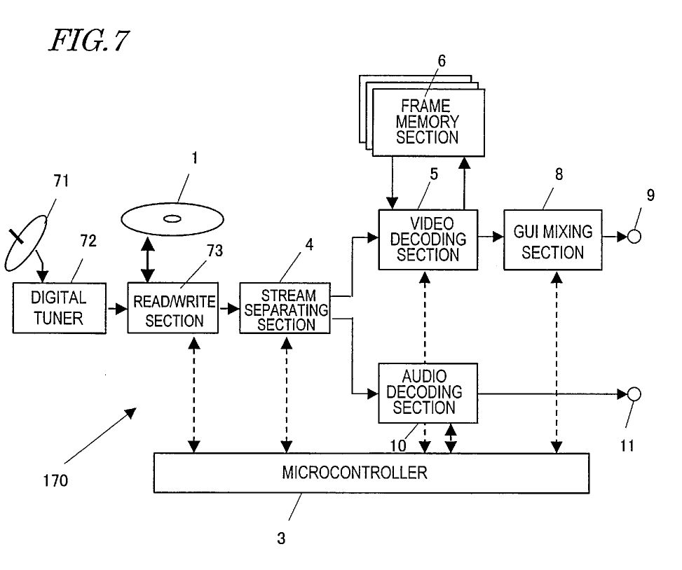

As for the first and second preferred embodiments, only playback-related processing performed by the components shown in FIG. 1 has been described. However, that does not mean that the configuration of a conventional recorder/player with a recording function as shown in FIG. 7 is not applicable to the present invention. An index point can be naturally put by utilizing the recording function (e.g., by detecting a fade-in or fade-out point automatically during recording). This is because pictures are decoded by the video decoding section and similar processing can also be done during recording.

Also, in both of the first and second preferred embodiments described above, only buttons for detecting fade-in and fade-out points automatically are displayed on the GUI image in the chapter registering mode. Optionally, a button for putting an index point on a normal frame that has been specified explicitly by the user may also be displayed and the operation of putting the index point may be started upon the selection made by him or her.

Furthermore, in the preferred embodiments described above, an index point is supposed to be put as either a fade-in point or a fade-out point by detecting a black level portion (i.e., a portion with a decreased level) of a picture. Optionally, a mode in which the index signal is inserted by detecting a white level portion (i.e., a portion with an increased level) of a picture may also be added and one of those two modes may be activated selectively.

Moreover, in both of the first and second preferred embodiments described above, the picture level is detected when a digital signal is decoded. This processing is applicable to not just a situation where a digital broadcast program is recorded and played back as digital information but also a situation where an analog broadcast program is digitized and then recorded or played back.

On top of that, the processing described above is also applicable to even a situation where an analog broadcast program is recorded or played back without being digitized. Specifically, an index point may be put by detecting the picture level of an analog video signal.

To put an index point on video represented by an analog video signal, an A/D converter and a picture level detecting section for analog signals are needed. The A/D converter should have the function of converting the analog video signal into a digital video signal and could be included in the read/write section 2.

Meanwhile, the picture level detecting section for analog signals may be arranged where the picture level detecting section 7 shown in FIG. 1 is located, for example, and has the function of detecting the picture level of the resultant digital video signal. However, since this digital video signal is not an MPEG-2 stream and has not been encoded, either, the processing that uses the DC components as described above cannot be carried out.

Thus, the picture level detecting section samples the respective picture levels of multiple pixels that form the video and calculates the average picture level of one frame. If this average picture level is used as a value corresponding to the average of the DC components described above, then the picture level detecting section can detect fade-in and fade-out points.

The operations of the recorder/player 100 of the first and second preferred embodiments described above may be implemented by a computer program that defines the processing procedure shown in FIG. 4 or 6. By executing such a computer program, the microcontroller 3 can operate the respective components of the recorder/player 100 and realize the processing described above. The computer program may be either circulated on the market after having been stored on a CD-ROM or any other appropriate storage medium or downloaded over telecommunications lines such as the Internet. Then, the computer system may operate as a player having the same function as the data processor described above.

### INDUSTRIAL APPLICABILITY

The recorder/player of the present invention detects fade-in and fade-out points by sensing the picture levels, thereby detecting a video boundary, such as a boundary between the content of a program received and a commercial message, highly accurately. If this boundary is registered as an index point, a recorder/player that can get editing work done efficiently afterward is realized.

1. A data processor comprising:
a picture level detecting section, which receives a video signal, representing a plurality of pictures to be presented one after another, and which detects the signal levels of the respective pictures based on the signal;
a frame memory section for storing the data of the respective pictures; and
a controller for adding index information to a data stream including the data of the respective pictures,
wherein the video signal is a digital signal that has been encoded based on DC component data and AC component data of the respective pictures, and
wherein the picture level detecting section detects the signal levels of the respective pictures based on the DC component data of multiple consecutive pictures and specifies a video changing point by reference to the detected signal levels of the respective pictures, and wherein the controller adds the index information to a data location, corresponding to the changing point, in the data stream.

2. The data processor of claim 1, wherein by reference the respective signal levels, the picture level detecting section detects at least one of a fade-in start point and a fade-out end point of the video and specifies that point as the changing point.

3. The data processor of claim 1, wherein the controller outputs a detection instruction to start detecting the changing point, and
wherein in accordance with the detection instruction, the picture level detecting section detects at least one of a fade-in start point and a fade-out end point of the video and specifies that point as the changing point.

4. The data processor of claim 3, further comprising a GUI mixing section for superimposing a GUI image on the video,
wherein in accordance with an instruction that has been given by way of the GUI mixing section, the controller outputs the detection instruction.

5. The data processor of claim 4, wherein the picture level detecting section specifies one of the fade-in start point and the fade-out end point of the video, which has been detected first after the detection instruction has been received, as the changing point.

6. The data processor of claim 1, wherein the controller defines chapters for the video at the changing point.

7. The data processor of claim 6, further comprising a GUI mixing section for superimposing a GUI image on the video,
wherein in accordance with a fade-in and/or fade-out detection instruction that has been given by way of the GUI mixing section, the picture level detecting section detects one of the fade-in start point and the fade-out end point of the video and specifies that point as the changing point.

8. (canceled)

9. (canceled)

10. (canceled)

11. The data processor of claim 1, further comprising:
a read section for playing back the data stream, including the video data, from a storage medium; and
a video decoding section for decoding the data stream being played back to generate the signal and to acquire the video data.

12. The data processor of claim 1, further comprising:
a receiving section for demodulating a broadcast wave and outputting a data stream including the video data; and
a video decoding section for decoding the data stream that has been output from the receiving section to generate the signal and to acquire the video data.

13. The data processor of claim 3, wherein the picture level detecting section specifies the changing point for predetermined ones of the intervals of the video.

14. The data processor of claim 13, wherein the picture level detecting section specifies the changing point for the predetermined intervals that have been either specified by a user or selected in advance.

15. The data processor of claim 1, further comprising a GUI mixing section for superimposing a GUI image on the video,
wherein the controller receives an instruction to set the index information for predetermined ones of the intervals of the video and outputs a detection instruction and a mixing instruction, and
wherein in accordance with the detection instruction, the picture level detecting section specifies the changing point for the predetermined intervals, and
wherein in accordance with the mixing instruction, the GUI mixing section outputs the video in the predetermined intervals and shows the presence of the changing point specified.

16. The data processor of claim 1, wherein the video signal is a digital signal representing an MPEG data stream that has been encoded based on the DC component data and the AC component data of the respective pictures.
